(19) United States
(12) Patent Application Publication
(10) Pub. No.: US 2025/0307956 A1
(43) Pub. Date: Oct. 2, 2025

(54) Systems And Methods For Use In Planting Seeds In Growing Spaces

(71) Applicant: CLIMATE LLC, Saint Louis, MO (US)

(72) Inventors: Morrison JACOBS, Saint Charles, MO (US); Chris LOCKWOOD, Bellevue, WA (US); Mohsen SHAHHOSSEINI, San Jose, CA (US); Shilpa SOOD, Apex, NC (US)

(21) Appl. No.: 19/088,664

(22) Filed: Mar. 24, 2025

Related U.S. Application Data
(60) Provisional application No. 63/571,249, filed on Mar. 28, 2024.

(51) Int. Cl. G06Q 50/02; A01C 7/10; G06N 20/20; G06Q 10/0631

(52) U.S. Cl. CPC G06Q 50/02; G06N 20/20; G06Q 10/06315; A01C 7/102

(57) ABSTRACT

Systems and methods are provided for use in recommending seeding rates for agricultural fields. An example computer-implemented method includes accessing data related to multiple agricultural fields in a region and separating the accessed data into a training set and a validation set, based on timing associated with harvest of crops of the multiple agricultural fields. The method also includes training an ensemble of models, representative of seeding rate relative to yield, based on the training set, and generating a response curve, defining a yield response to seeding rate, based on the trained ensemble of models and generating a validation curve, based on the validation set. The method further includes calculating an error between the generated response curve and the validation curve and recommending a seeding rate for a target field in the region, based on the response curve and the calculated error.

### CROSS-REFERENCE TO RELATED APPLICATION

This application claims the benefit of, and priority to, U.S. Provisional Application No. 63/571,249, filed Mar. 28, 2024. The entire disclosure of the above application is incorporated herein by reference.

### FIELD

The present disclosure generally relates to systems and methods for use in planting seeds in growing spaces (e.g., in agricultural fields, etc.), and more particularly, to systems and methods for use in determining seeding rates for planting seeds in the growing spaces.

### BACKGROUND

This section provides background information related to the present disclosure which is not necessarily prior art.

It is known for seeds to be grown in fields, whereby the resulting plants, or parts thereof, are harvested and used for various purposes. For example, corn may be grown by a farmer in a field owned, leased, or managed by the farmer, and the corn grown and harvested from the field may then be transferred for subsequent use (e.g., for consumption by livestock, etc.). Consequently, farmers and other growers often seek to plant particular seeds based on specific aims of the farmers, and based on performance of the seeds in terms of yield. In connection therewith, the farmers may rely on past performance of seeds, or on recommendations, by seed providers, in selecting seeds for planting.

### SUMMARY

This section provides a general summary of the disclosure and is not a comprehensive disclosure of its full scope or all of its features.

Example embodiments of the present disclosure generally relate to computer-implemented methods for use in recommending seeding rates for planting seeds in agricultural fields. In one example embodiment, such a method generally includes accessing, by a computing device, data related to multiple agricultural fields in a region, the data including multiple observations, which are indicated by yield of the multiple agricultural fields over at least one season, seeding rate of the multiple agricultural fields over the at least one season, location, soil data representative of the multiple agricultural fields, and genetic data for seeds planted in the multiple agricultural fields over the at least one season; separating, by the computing device, the accessed data into a training set and a validation set, based on timing associated with harvest of crops of the multiple agricultural fields; training an ensemble of models, representative of seeding rate relative to yield, based on the training set; generating a response curve, defining a yield response to seeding rate, based on the trained ensemble of models; generating a validation curve, based on the validation set; calculating an error between the generated response curve and the validation curve; and recommending a seed rate for a target field in the region, based on the response curve and the calculated error.

Example embodiments of the present disclosure also generally relate to systems for use in recommending seeding rates for planting seeds in agricultural fields. In one example embodiment, such a system generally includes at least one computing device configured to access data related to multiple agricultural fields in a region, the data including multiple observations, which are indicated by yield of the multiple agricultural fields over at least one season, seeding rate of the multiple agricultural fields over the at least one season, location, soil data representative of the multiple agricultural fields, and genetic data for seeds planted in the multiple agricultural fields over the at least one season; separate the accessed data into a training set and a validation set, based on timing associated with harvest of crops of the multiple agricultural fields; train an ensemble of models, representative of seeding rate relative to yield, based on the training set; generate a response curve, defining a yield response to seeding rate, based on the trained ensemble of models; generate a validation curve, based on the validation set; calculate an error between the generated response curve and the validation curve; and recommend a seed rate for a target field in the region, based on the response curve and the calculated error.

Example embodiments of the present disclosure also generally relate to non-transitory computer readable storage media, which include executable instructions for recommending seeding rates, which when executed by at least one processor, cause the at least one processor to perform one or more of the steps and/or operations described herein.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an example system for accessing data related to growing spaces and historical selection data from one or more growers, for use in recommending seeding rates for one or more agricultural fields;

FIGS. 2A-2C illustrate different example curves of seeding rate relative to yield;

FIG. 3 illustrates an example method that may be used in the system of FIG. 1 for use in recommending seeding rates for one or more agricultural fields;

FIGS. 4A-4B are block diagrams that illustrate example computer systems upon which one or more embodiments of the present disclosure may be implemented; and

FIG. 5 illustrates an example implementation architecture that may be included and/or implemented in a computer system of FIG. 1 and/or FIGS. 4A-4B, for use in performing one or more of the functions described herein.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Seeds to be planted in fields, and the parameters of the planting (e.g., seeding rate, etc.), are selected by growers (broadly, users) based at least in part on the suitability of the seeds to the fields (or to one or more representative fields) and past performance of the seeds and/or planting parameters. Through years, it may be apparent that seed selection and/or planting parameters may not always be based on objective data related to the seeds, the fields, etc. In this way, the performance of the fields in producing yield is impacted by biases or other logic applied by users in planting the seeds. As such, the planting decisions may provide inefficiencies in crop performance.

Uniquely, the systems and methods herein provide for identifying a seeding rate (or rates) at which a desired seed (or seeds) is(are) to be planted in a field (or fields) to provide enhanced crop performance.

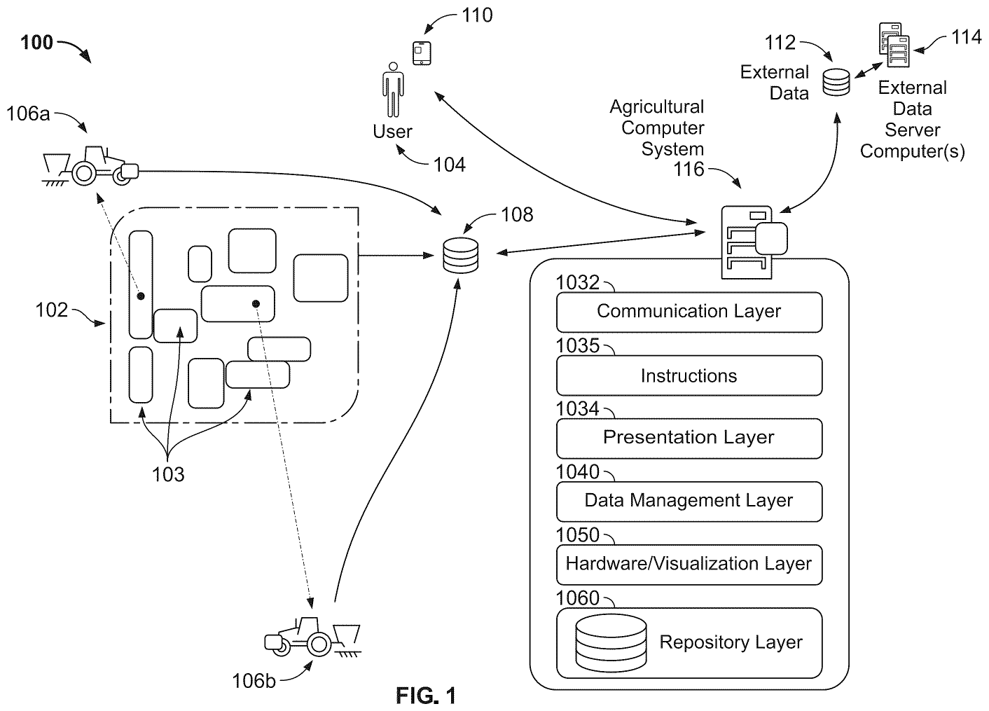

FIG. 1 illustrates an example system 100 in which one or more aspect(s) of the present disclosure may be implemented. Although the system 100 is presented in one arrangement, other embodiments may include the parts of the system 100 (or other parts) arranged otherwise depending on, for example, relationships between users, farm equipment and fields; data flows; types of seeds; types and/or locations of fields; planting activities; privacy and/or data requirements; etc.

As shown, the system 100 generally includes a region 102, which is divisible into different fields 103. The fields 103 may be distributed throughout the region 102, whereby some fields 103 may be adjacent to one another, while other fields 103 are spaced apart from one another. In general, the fields 103 are owned, operated and/or managed by user 104. In this way, the user 104 may include a farmer, or a grower business or entity, which is responsible for planting, growing, and harvesting crops from the fields 103. As such, the user 104 is a person, or group of people, which are responsible for making decisions related to the fields 103 (e.g., a farmer, etc.). For example, the user 104 may decide the seeds to be planted in the fields 103 and the planting parameters associated with planting the seeds in the fields 103 (e.g., seeding rate, etc.), management practices to employ, and harvest timing, etc.

In addition to the fields 103 in FIG. 1, the system 100 also includes a number of agricultural equipment (e.g., equipment 106a-b, etc.), a data server 108 (or multiple data servers), and an agricultural computer system 116, each of which is coupled to (and is in communication with) one or more network(s). The network(s) is/are indicated generally by arrowed lines in FIG. 1, and may each include, without limitation, one or more of a local area network (LAN), a wide area network (WAN) (e.g., the Internet, etc.), a mobile/cellular network, a virtual network, and/or another suitable public and/or private network capable of supporting communication among parts of the system 100 illustrated in FIG. 1, or any combination thereof.

In this example embodiment, the agricultural equipment includes a planting device 106a and a planting device 106b, each disposed in one of the fields 103. It should be appreciated that different numbers and/or types of planting devices, which may be distributed differently among the fields 103, may be included in other system embodiments.

The planting devices 106a-b may include, for example, planters or other mechanisms for planting seeds in the fields 103 illustrated in FIG. 1. The planting devices 106a-b may be automated, or reliant, at least in part, on a human operator, etc. The planting devices 106a-b, in general, may be configured to disturb the soil in the fields 103, place a seed, and repeat at one or more planting speeds, etc. In connection therewith, the planting devices 106a-b are configured to perform the planting operations according to specific planting parameters. For example, the planting devices 106a-b are configured to plant particular seeds in a location at a specific seeding rate, where the seeding rate may change from location to location. In this manner, one of the fields 103 may include a consistent seeding rating, or multiple different seeding rates in different parts thereof. As the planting parameters are implemented, the planting devices 106a-b are configured to record data indicative of the planting parameters. That is, the planting devices 106a-b may be configured to confirm compliance with planting parameters, or actually measure the planting parameters as the planting progresses.

The fields 103 historically have been planted, by the planting devices 106a-b, and harvested, by other farm equipment (not shown). The fields 103 may then be again planted and harvested, season over season. In connection therewith, data is captured and/or collected from the fields 103. The data may be collected manually, or automatically, etc.

In this example embodiment, the fields 103 are included in a trial experiment, in which the same seed is planting in ones of the fields 103, or parts of the fields 103, at multiple different seeding rates. As such, the seeding rates and the locations (e.g., longitude and latitude, etc.) of the seeding rates in the fields 103 is part of the data collected for the fields 103, by the planting devices 106a-b. In addition to seeding rate, the planting devices 106a-b are each also configured to identify the seed being planted, for example, by identifier, brand, relative maturity, etc. Again, the planting devices 106a-b are configured to transmit the planting data to the data server 108 (via one or more networks), which, in turn, is configured to store the data.

In addition, as it relates to the trial experiment, at harvest, yield data (or harvest data) is collected and/or captured (e.g., by harvesting farm equipment (not shown) etc.) for the locations of the fields 103 and also forms part of the data collected and/or captured. The harvesting farm equipment is configured to transmit the yield data to the data server 108, which, in turn, is configured to store the data.

As part of the trial experiment, the soil data is also collected and/or captured for the fields 103, by still other farm equipment (not shown) or from one or more external data sources 112. Specifically, the soil features represented in the data include, without limitation, bdod (bulk density of the fine earth fraction, in kg dm-3), cec (Cation Exchange Capacity of the soil, in cmol (+) kg-1), cfvo (volume fraction of coarse fragments (>2 mm), in %), nitrogen (total nitrogen (N), in g kg-1), phh2o (pH (H2O)), sand (sand (>0.05 mm) in fine earth, in %), silt (silt (0.002-0.05 mm) in fine earth, in %), clay (clay (<0.002 mm) in fine earth, in %), soc (soil organic carbon in fine earth, in g kg-1), etc. Other soil data may include organic carbon density, organic carbon stocks, etc., as desired, etc. In connection with the specific soil data above, the specific data is collected and/or captured at one or more depths in the soil, such as, for example, at 0-5 cm, 5-15 cm, 15-30 cm, 30-60 cm, 60-100 cm, 100-200 cm, etc. It should be appreciated that other depths of soil data may be collected and/or captured from the fields 103. Based on the above, the soil data is expressed as a soil grid, indicative of location and the soil data at the different depths and the location. The location may be identified by geohashes, or unique identifiers for plots of the fields 103, in general or based on intersection with boundaries of the fields 103.

With regard to the one or more data sources 112, the data related to the trial experiments include genetic data for the seeds planted in the fields 103. Genetic data may be represented in a variety of different manners. In this example embodiment, the genetic data includes marker data for the seeds, which is subject to one or more dimensionality reduction algorithms, such as, for example, principal component analysis (PCA) and/or neural network autoencoder, etc. For example, the genetic data may include an array of marker data that tracks the allele values for single nucleotide polymorphisms present in seed products. In connection therewith, underlying marker technology (associated with the genetic data) may include, without limitation, TaqMan markers, genotyping by sequencing, etc.

Additional data may also be collected and/or captured for the fields 103. Such data may optionally include weather data, such as, for example, precipitation data, rainfall rate(s), predicted rainfall, water runoff rates per region, temperature(s) (e.g., maximum, minimum, average, etc.), wind speeds and/or directions, forecasts, pressures, visibility, clouds, heat index, dew points, humidity, snow cover/depth, air quality, sunrise/daylight, sunset, sunlight, etc. It should be understood that still other weather data may optionally be part of the data referenced above.

While the above is described with respect to a specific trial experiment, the data may be collected from general farming operations related to the fields 103.

In any case, the data server 108, in turn, is configured to store the data in one or more data structures. In general, in this example embodiment, the data server 108 is configured to store data by year (e.g., Year_Y−1, Year_Y, Year_Y+1, etc.), which corresponds to the different growing years (e.g., 2020, 2021, 2022, etc.) for the growing space 102 (and/or plots, fields 103, etc. within the growing space 102, etc.). Then, for each year, the data structure(s) of the data server 108 will include the yield data, seeding rate data, location data, soil data, genetic data, weather data, etc.

In connection with the above, in this example embodiment, the agricultural computer system 116 is configured to identify a seeding rate for one of the agricultural fields 103 and to recommend the seeding rate to a grower associated with the field 103.

Initially, the agricultural computer system 116 is configured to train a machine learning model to define a seeding rate (or density) by yield curve for the seeds planted in the fields 103. As part thereof, the agricultural computer system 116 is configured to define a training set of data and a validation set of data. The training set and the validation set generally include a division of the data above, where the seeding rate, yield, seed, soil data and genetic data for the seed are included in the data. The division may be based on years or dates, regions or locations, seeds, etc. In one example, the validation set is defined by n-fold or year cross validation, where n environments (e.g., field/year combinations, etc.) or years are withheld for use in validation, i.e., as the validation set.

Next, in this example embodiment, the agricultural computer system 116 is configured to generate additional data to be included in the training set of data. The generated data may be referred to herein as synthetic observations. The agricultural computer system 116 is configured to generate the synthetic observations by plotting, for each same seed and/or environment, the yield versus the seeding rate. The agricultural computer system 116 is configured to then fit a specific response curve/distribution to the plotted data points. The response curve may include a curve as defined, or described in W. G. Duncan, “The Relationship Between Corn Population and Yield”, Agronomy Journal, Published February 1958, which is incorporated herein by reference. Other response curves, which define the relationship between yield and population of seeds (or seed density or seeding rate) may be employed in other embodiments.

When the curve or distribution is fit, the agricultural computer system 116 is configured to define the synthetic observations along the curve or distribution. The number of synthetic observations is limited to a percentage of the training set of data. For example, the number of synthetic observations may be less than about 70%, less than about 50%, less than about 30%, less than about 25%, less than about 5%, etc., of the data included the training set. In addition, the agricultural computer system 116 is configured, in this example, to include noise, and specifically, Gaussian noise, in the synthetic observations, as N(μ,σ²), where Nis a normal distribution with mean μ and standard deviation σ (e.g., N(0,σ²), etc.). It should be understood that other mechanisms may be employed in other embodiments to inject noise into the synthetic observations.

Once the synthetic observations are defined, the agricultural computer system 116 is configured to add the synthetic observations to the training set of data. It should be appreciated that, in this embodiment, the synthetic observations are added to the training set of data, but not to the validation set of data. That said, the synthetic observations may be added to the validation set in other embodiments of the present disclosure.

In this example embodiment, with the training set of data defined, the agricultural computer system 116 is configured to train a model based on the training set of data. In addition, in this example embodiment, the model includes an ensemble of models. In particular, the model includes an ensemble of XGBRegressor models, which are regression-specific implementations of XGBoost (eXtreme Gradient Boosting). The model parameters of the models, in this example, are defined in three classes: general parameters, booster parameters, and task parameters. For example, a booster parameter is defined to select a particular booster to use, while a base_score parameter is the initial prediction score of all instances, and global bias and max_depth parameters are the maximum depth of the tree. Other parameters to be set prior to training and using the model, as understood by those skilled in the art, are provided in Table 1, below.

TABLE 1
objective (e.g., reg:squarederror, etc.)

base_score
booster
callbacks
colsample_bylevel
colsample_bynode
colsample_bytree
device
early_stopping_rounds
enable_categorical (e.g., FALSE, etc.)
eval_metric
feature_types
gamma
grow_policy
importance_type
interaction_constraints
learning_rate
max_bin
max_cat_threshold
max_cat_to_onehot
max_delta_step
max_depth
max_leaves
min_child_weight
missing
monotone_constraints
multi_strategy
n_estimators
n_jobs
num_parallel_tree
random_state
reg_alpha
reg_lambda
sampling_method
scale_pos_weight
subsample
tree_method
validate_parameters
verbosity

In connection with the specific ensemble of XGBRegressor models, for example, in this example embodiment, the objective is set to reg:squarederror for regression with squared loss; enable_categorical is set to false; max depth is set to 3; tree_method is set to auto; and n_estimators is set to 1001. It should be appreciated that other values for these and other parameters are to be employed in various instances of the XGBRegressor models consistent with the description herein. That is, it should be understood that in this example embodiment, and others, parameters are selected and/or tuned (or left as default) using a cross validation approach on a subset of the data to enhance and/or optimize performance.

For the training, in view of the parameters and training set above, specific trees of the ensemble of XGBRegressor models are defined, which cooperate to predict yield based on the input seeding rate.

That is, each predicted output of seeding rate by yield is an average of the predictions from all members of the ensemble of models. In this way, the agricultural computer system 116 is configured to generate seeding rate (or density) by yield curves, or D×Y curves, through iterating over a configuration defined range of seeding rates.

In this example embodiment, the D×Y curves are variable based on the prediction of the ensemble of models. Optionally, the agricultural computer system 116 is configured to smooth the curve by application of a response curve, or by fitting a curve to the predicted outputs generated by the models, as explained herein. The smoothed D×Y curve then defines the model for prediction of yield based on seeding rate for the specific seed and field combination(s).

It should be appreciated that other models may be used in other system embodiments of the present disclosure. For instance, random forest and/or neural network models, and variants thereof, may be used in other embodiments of the present disclosure.

Next, the agricultural computer system 116 is configured to validate the trained model, based on the validation set of data. In this embodiment, to limit information leakage, validation is done by leaving or holding out entire environments and/or year combinations, as the validation set of data, as explained above. Specifically, for environments, field/year combinations are divided into separate training and validation sets of data based on specific environments. And, for year, the training set of data includes all years prior to and/or after a hold out year which is defined as the validation set of data.

In this example embodiment, the agricultural computer system 116 is configured to validate the trained model based on yield prediction, seeding rate and economic return on investment (ROI). Yield is provided based on two yield dimensions, which relate to the D×Y curve prediction and point prediction. That is, the yield is based on a seeding rate intercept of the D×Y curve. The prediction point relies on the root-mean-squared error or RMSE between yield prediction and observed point yield prediction for the data included in the validation set, i.e., the holdout observations. In this way, the validation is provided with limited or no assumptions about yield versus seed density relationship.

The agricultural computer system 116 is configured to fit a Malthus model curve based on the validation set of data. Hereinafter, a Malthus model curve refers to a curve that may be fit to the observations consistent with the description in, for example, W. G. Duncan, “The Relationship Between Corn Population and Yield,” Agronomy Journal, Published February 1958.

In this example embodiment, the agricultural computer system 116 is configured to then compare the RMSE of the predicted yield curve or curve parameters to the observed fitted curve. For the validation set of data points, individually, the RMSE is calculated according to Equation (1) below, where Ŷᵢ is the model yield, Y_{obs,i} is the observed yield, and N is the number of observed yields.

$${RSME}_{yld} = \sqrt{\frac{1}{{N}_{i}} {\sum }_{i = 1}^{{N}_{i}} {( {Y}_{obs , i} - {\hat{Y}}_{i} )}^{2}} \qquad ( 1 )$$

And, for the fitted curve based on the validation set of data, the RMSE is calculated according to Equation (2) below, where Ŷᵢ is the model yield, Y_{obs,i} is the corresponding yield on the fitted curve, and N is the number of data points to be considered. In connection therewith, tens, hundreds, thousands, hundreds of thousands, etc. data points may be considered (e.g., upwards of 135,000 seeds/hectare in 1,000 seed increments to help ensure appropriate coverage and resolution of yield (e.g., to approximate density response across different environments, etc.), etc.). That said, it should be appreciated that the number of data points considered may be varied by region and may be somewhat empirical in nature.

$${RSME}_{DxY} = \sqrt{\frac{1}{{N}_{j}} {\sum }_{j = 1}^{{N}_{j}} {( {Y}_{obs , j} - {\hat{Y}}_{j} )}^{2}} \qquad ( 2 )$$

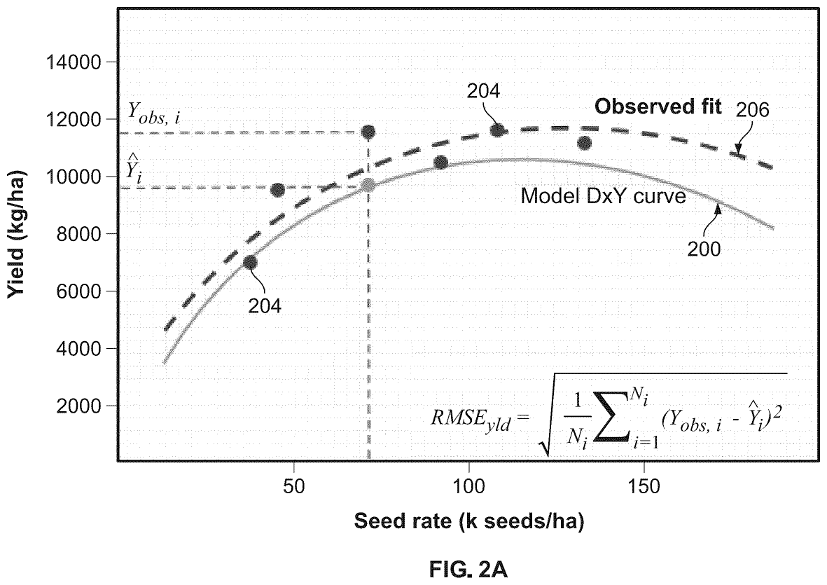

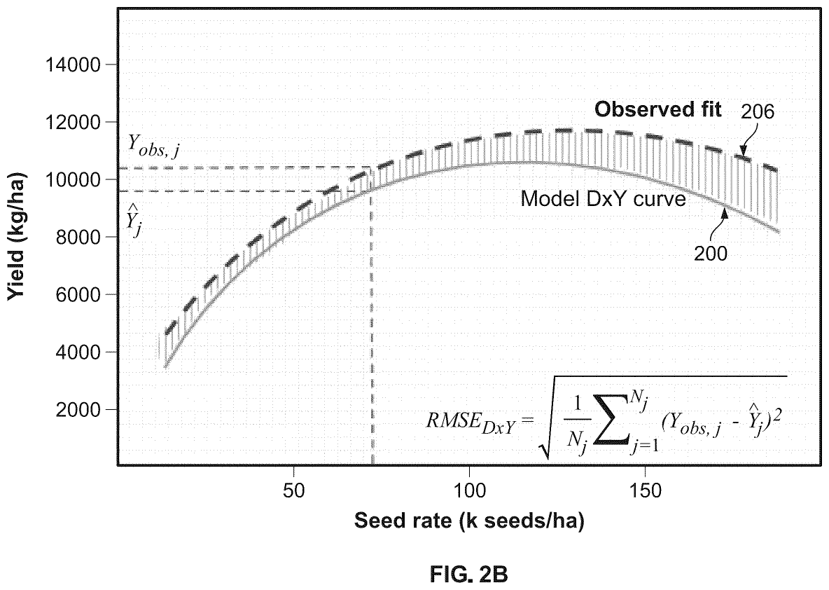

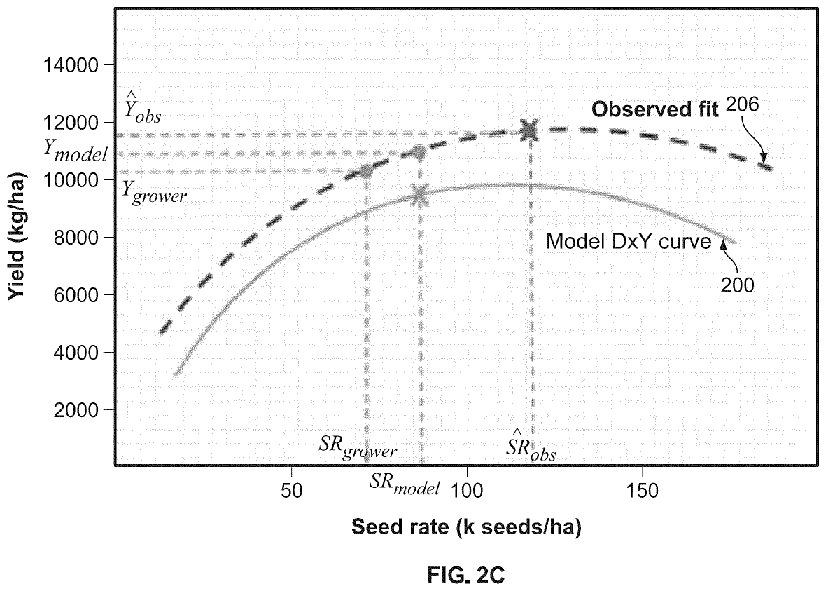

With reference to FIGS. 2A-2B, the model curve 200 (as generated by the model) is illustrated in a graph of yield versus seeding rate, as the Model D×Y curve. In another embodiment, the model may indirectly generate the model curve 200 by generating one or more curve parameters (e.g., one or more derivatives or slopes, etc.) of the curve 200. Also, in FIG. 2A, the data points 204 of the validation set of data are shown, along with the fitted curve 206 for the data points of the validation set. The fitted curve 206 is shown in both FIG. 2A and FIG. 2B. In FIG. 2A, it should be understood that the RMSE metric is calculated between the model D×Y curve 200 and the data points 204 of the validation set, consistent with Equation 1 above. Here, the number of data points 204 in the validation set, or the value of N, is six. Conversely, in FIG. 2B, the RMSE is calculated based on the fitted curve 206, consistent with Equation (2), rather than the individual data points of the validation set. In this way, the RMSE metric assumes that the yield density response follows the generated validation curve. Comparing accuracy along the entire curve ensures that the model is providing reasonable recommendations between and beyond observed data points of the validation set from which the observed fit curve is generated, which is associated with a relatively smooth and rational yield response.

Next, in the system 100, the agricultural computer system 116 is configured to determine a seeding rate recommendation and potential ROI.

As illustrated in FIG. 2C, for example, the seed density model is utilized to provide seeding rate recommendations to growers. The optimal seeding rate is a function of seed cost (c) and commodity price (p). Where commodity price is high and seed cost is low, optimizing yield will provide more value. In doing so, decreasing commodity prices and increasing seed costs result in lower return on investment near optimal yield. To account for the same, the agricultural computer system 116 is configured to use a typical economic costs by region and to calculate the marginal ROI. This generates a second curve which has an optimal ROI that falls somewhere below the highest yielding seeding rate.

The above is illustrated in FIG. 2C, where the fitted curve 206 defines a maximum yield, at its highest point, which is designated Ŷ_{obs} and corresponds to a specific seeding rate, [symbol] _{obs}. Additionally, there is a grower designated seeding rate, which is used, or [symbol] often used, by the grower to plant a given field. As further shown in FIG. 2C, the grower seeding rate is designated as SR_{grower} and corresponds to a yield designated Y_{grower}. The grower seeding rate may be based on the particular user 104, or neighboring users in the same region as the user 104 and/or the agricultural fields 103. Where the profit is equal to the yield multiplied by the commodity price (p), minus the seeding rate multiplied by the seed cost (c), the above illustrates the associated ROI of the seeding rate. The profit for the grower (e.g., the user 104, etc.) may then be compared to the profit for the observed maximum yield.

Additionally, as shown in FIG. 2C, the model curve 200 indicates a yield and seeding rate combination, Y_{model} and SR_{model}. The agricultural computer system 116 is configured to determine profit (P) for various pairs of points along the model curve 200 (e.g., \hat{P}_{obs}=p*Ŷ_{obs}−c* [symbol] _{obs}); P_{grower}=p*Y_{grower}−c*SR_{grower}; P_{model}=p*Y_{model}−c*SR_{model}, etc.) and to compare the profit to the profit of the grower's seeding rate, SR_{grower}. The win rate may be defined as a percentage, where the model provides greater profit than the grower's seeding rate in some percentage of the points along the model curve 200. In connection with the above, the fitted curve 206 is generated from held out field observations, and is utilized as ground truth. As such, in this scenario, the yield and economics of the model prediction are compared to the observed fit/ground truth for a given seeding rate.

The agricultural computer system 116 is configured to output a seeding rate recommendation to the user 104 based on one or more of the pairs of seeding rates and yields, from the model curve, based on, in turn, the associated profit, in general or relative to the profit expected by the grower's seeding rate, SR_{grower}. In doing so, the recommendation may be compared to a current seeding rate used by the user 104. Further, as described more below, the recommendation may be used to generate a planting prescription for a field, at the recommended seeding rate (and, in some embodiments, regenerated based on user input, etc.).

With reference again to FIG. 1, in this example embodiment, the agricultural computer system 116 is also programmed, or configured, to output the recommendation to the user 104. The recommendation may be provided in a table, in which the predicted yields are included or may be included in an interface along with a basis for the selection, recommendation metrics, field guide information, etc.

The seeding rate recommendation is then selected by the user 104, via a field manager computing device 110 associated with the user 104. This may include the user 104 ordering and/or purchasing particular seeds/hybrids, for instance, via the agricultural computer system 116, etc. (e.g., whereby the agricultural computer system 116 receives the order, purchase request, etc. from the grower/user, in response to output of the seeding rate recommendation to the grower/user and a corresponding selection by the grower/user; etc.), and then the agricultural computer system 116 directing the seeds/hybrids to the user 104 (e.g., delivering the selected seeds to the target field, etc.). In addition, the seeding rate may be executed (e.g., planted, etc.), by the user 104 or other party, for example, in the fields 103. In doing so, broadly, the desired seeds are included (e.g., planted, etc.) in the fields 103, by the planting equipment 106a-b, at the recommended seeding rate, based on one or more scripts generated and/or compiled by the agricultural computer system 116. This may include the agricultural computer system 116 generating planting instructions—as the script(s)—based on the seeding rate recommendation and providing the instructions to the planting equipment 106a-b whereby the planting equipment 106a-b operates, in response to the instructions, to plant the seeds at that rate in the fields 103, with only limited additional input from the user 104 (e.g., upon delivery of the selected seeds to the planting equipment 106a-b, etc.). In one or more embodiments, the planting equipment 106a-b may be controlled automatically, through the scripts generated, by the agricultural computer system 116, in response to the user's selection and/or the identification by the agricultural computer system 116.

The user 104 (e.g., a grower, a sales representative, another user, etc.) in the system 100 may own, operate or possess the field manager computing device 110 in a field location, or associated with a field location, such as in one of the fields 103 intended for agricultural activities or a management location for the fields 103. In this example embodiment, the field manager computing device 110 is programmed, or configured, to provide field data to the agricultural computer system 116 via one or more networks (as indicated by arrowed lines in FIG. 1). Again, the network(s) may each include, without limitation, one or more of a local area networks (LANs), wide area network (WANs) (e.g., the Internet, etc.), mobile/cellular networks, virtual networks, and/or another suitable public and/or private networks capable of supporting communication among parts of the system 100 illustrated in FIG. 1, or any combination thereof.

Examples of field data may include, for example, (a) identification data (for example, acreage, field name, field identifiers, geographic identifiers, boundary identifiers, crop identifiers, and any other suitable data that may be used to identify farm land; (b) harvest data (for example, crop type, crop variety, crop rotation, whether the crop is grown organically, harvest date, yield, etc.), (c) soil data (for example, type, bulk density of the fine earth fraction, Cation Exchange Capacity of the soil, volume fraction of coarse fragments, nitrogen, phh2o, sand, silt, soil organic carbon, etc.), (d) planting data (for example, planting date, seed(s) type, relative maturity (RM) of planted seed(s), seed population (or seeding rate), etc., (e) weather data (for example, precipitation, rainfall rate, predicted rainfall, water runoff rate region, temperature, wind, forecast, pressure, visibility, clouds, heat index, dew point, humidity, snow depth, air quality, sunrise, sunset), and (f) other data described herein, etc.

As described, data server 108 is communicatively coupled to the agricultural computer system 116 and is programmed, or configured, to send external data (e.g., data associated with the fields 103, etc.) to agricultural computer system 116 via the network(s) herein (e.g., for use in recommending seeding rates for the fields 103 identified by the user 104, etc.). The data server 108 may be owned or operated by the same legal person or entity as the agricultural computer system 116, or by a different person or entity, such as a government agency, non-governmental organization (NGO), and/or a private data service provider. Examples of external data include weather data, imagery data, soil data, seed data and seed selection data as described herein, data from the various fields 102 herein, or statistical data relating to crop yields, among others. The weather data, for example, may include past and present weather data as well as forecasts for future weather data. In an embodiment, data server 108 comprises a plurality of servers hosted by different entities. For example, a first server may contain soil composition data while a second server may include weather data. Additionally, soil data may be stored in multiple servers. For example, one server may store data representing percentage of sand, silt, and clay in the soil while a second server may store data representing percentage of organic matter (OM) in the soil. Further, in some embodiments, the data server 108, again, may include data associated with the fields 102 with regard to available seeds for use in comparisons, etc.

That said, external data may include the same type of information as field data. In some embodiments, the external data may also be provided by data server 108 owned by the same entity that owns and/or operates the agricultural computer system 116. For example, the agricultural computer system 116 may include a data server focused exclusively on a type of data that might otherwise be obtained from third party sources, such as weather data. In some embodiments, data server 108 may actually be incorporated within the system 116.

The system 100 also includes, as described above, the planting equipment 106a-b configured to plant one or more seeds in the fields 102. In some examples, the planting equipment 106a-b may have one or more remote sensors fixed thereon, where the sensor(s) are communicatively coupled, either directly or indirectly, via the planting equipment 106a-b to the agricultural computer system 116 and are programmed, or configured, to send sensor data to agricultural computer system 116.

Additional examples of agricultural (or farm) equipment that may be included in the system 100 include tractors, combines, other harvesters, planters, trucks, fertilizer equipment, aerial vehicles including unmanned aerial vehicles, and any other item of physical machinery or hardware, typically mobile machinery, and which may be used in tasks associated with agriculture and/or related to operations described herein. In some embodiments, a single unit of the agricultural apparatus may comprise a plurality of sensors that are coupled locally in a network on the apparatus. Controller area network (CAN) is an example of such a network that can be installed in combines, harvesters, sprayers, and cultivators. In connection therewith, then, an application controller associated with the apparatus may be communicatively coupled to agricultural computer system 116 via the network(s) and programmed, or configured, to receive one or more scripts that are used to control an operating parameter of the agricultural apparatus (or another agricultural vehicle or implement) from the agricultural computer system 116 (e.g., planting instructions generated by the agricultural computer system 116 and transmitted to a planter agricultural apparatus that then control operation of the planter agricultural apparatus to plant certain selected seeds (e.g., in a particular manner, etc.), etc.). For instance, a controller area network (CAN) bus interface may be used to enable communications from the agricultural computer system 116 to the planting equipment 106a-b, for example, such as how the CLIMATE FIELDVIEW DRIVE, available from Climate LLC, of Saint Louis, Missouri, is used. Sensor data may consist of the same type of information as field data. In some embodiments, remote sensors may not be fixed to an agricultural apparatus but may be remotely located in the field and may communicate with one or more networks of the system 100.

As indicated above, the network(s) of the system 100 are generally illustrated in FIG. 1 by arrowed lines. In connection therewith, the network(s) broadly represent any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. For instance, the planting equipment 106a-b in the system 100, data server 108, agricultural computer system 116, and other elements of the system 100 may each comprise an interface compatible with the network(s) and programmed, or configured, to use standardized protocols for communication across the networks, such as TCP/IP, Bluetooth, CAN protocol and higher-layer protocols, such as HTTP, TLS, and the like.

Agricultural computer system 116 is programmed, or configured, to receive field data from field manager computing device 110, external data 112 from data server 114, and sensor data from one or more remote sensors in the system 100. Agricultural computer system 116 may be further configured to host, use or execute one or more computer programs, other software elements, digitally programmed logic, such as FPGAs or ASICs, or any combination thereof to perform translation and storage of data values, construction of digital models of one or more crops on one or more fields, generation of recommendations and notifications, and generation and sending of scripts, in the manner described further in other sections of this disclosure.

In an embodiment, agricultural computer system 116 is programmed with or comprises a communication layer 1032, a presentation layer 1034, a data management layer 1040, a hardware visualization layer 1050, and a model and field data repository layer 1060. “Layer,” in this context, refers to any combination of electronic digital interface circuits, microcontrollers, firmware, such as drivers, and/or computer programs, or other software elements.

Communication layer 1032 may be programmed, or configured, to perform input/output interfacing functions including sending requests to field manager computing device 110, data server 108, and remote sensor(s) for field data, external data, and sensor data respectively. Communication layer 1032 may be programmed, or configured, to send the received data to model and field data repository layer 1060 to be stored as field data (e.g., in computer system 116, etc.).

Presentation layer 1034 may be programmed, or configured, to generate a graphical user interface (GUI) to be displayed on field manager computing device 110 (e.g., for use in interacting with agricultural computer system to identify fields 102, recommended seeding rates, predicted yields, etc.) or other computers that are coupled to the system 116 through the network(s). The GUI may comprise controls for inputting data to be sent to agricultural computer system 116, generating requests for models and/or recommendations, and/or displaying recommendations, notifications, models, and other field data.

Data management layer 1040 may be programmed, or configured, to manage read operations and write operations involving the repository layer 1060 and other functional elements of the system, including queries and result sets communicated between the functional elements of the system and the repository. Examples of data management layer 1040 include JDBC, SQL server interface code, and/or HADOOP interface code, among others. Repository layer 1060 may comprise a database. As used herein, the term “database” may refer to either a body of data, a relational database management system (RDBMS), or to both. As used herein, a database may comprise any collection of data including hierarchical databases, relational databases, flat file databases, object-relational databases, object oriented databases, distributed databases, and any other structured collection of records or data that is stored in a computer system. Examples of RDBMS's include, but are not limited to including, ORACLE®, MYSQL, IBM® DB2, MICROSOFT® SQL SERVER, SYBASE®, and POSTGRESQL databases. However, any database may be used that enables the systems and methods described herein.

When field data is not provided directly to the agricultural computer system 116 via one or more agricultural machines or agricultural machine devices that interact with the agricultural computer system 116, the user 104 may be prompted via one or more user interfaces on the device 110 (served by the agricultural computer system 116) to input such information for use in effecting the selections herein.

In an example embodiment, the agricultural computer system 116 is programmed to generate and cause displaying of a graphical user interface comprising a data manager for data input. After one or more fields have been identified using the methods described above, the data manager may provide one or more graphical user interface widgets which when selected can identify changes to the field, soil, crops, tillage, or nutrient practices, and/or which may provide comparison data related to target seeding rates identified herein. The data manager may include a timeline view, a spreadsheet view, a graphical view, and/or one or more editable programs.

In an embodiment, model and field data is stored in model and field data repository layer 1060. Model data comprises data models created for one or more fields. For example, a crop model may include a digitally constructed model of the development of a crop on the one or more fields. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer. The model may include a model of past events on the one or more fields, a model of the current status of the one or more fields, and/or a model of predicted events on the one or more fields. Model and field data may be stored in data structures in memory, rows in a database table, in flat files or spreadsheets, or other forms of stored digital data.

With further reference to FIG. 1, in an embodiment, instructions 1035 of the agricultural computer system 116 may comprise a set of one or more pages of main memory, such as RAM, in the agricultural computer system 116 into which executable instructions have been loaded and which when executed cause the agricultural computer system 116 to perform the functions or operations that are described herein. For example, the instructions 1035 may comprise a set of pages in RAM that contain instructions which, when executed, cause performing the seed identification functions described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system may vary depending on the memory architecture or processor architecture. In another embodiment, the instructions 1035 also may represent one or more files or projects of source code that are digitally stored in a mass storage device, such as non-volatile RAM or disk storage, in the agricultural computer system 116 or a separate repository system, which when compiled or interpreted cause generating executable instructions which when executed cause the agricultural computer system 116 to perform the functions or operations that are described herein. In other words, the drawing figure may represent the manner in which programmers or software developers organize and arrange source code for later compilation into an executable, or interpretation into bytecode or the equivalent, for execution by the agricultural computer system 116.

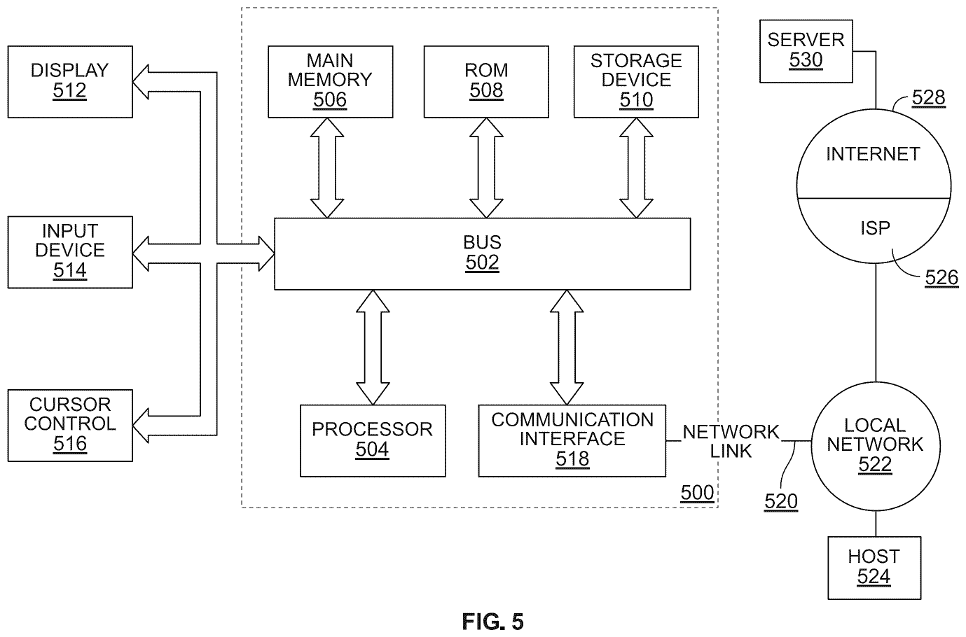

Hardware visualization layer 1050 comprises one or more central processing units (CPUs), memory controllers, and other devices, components, or elements of a computer system, such as volatile or non-volatile memory, non-volatile storage, such as disk, and I/O devices or interfaces as illustrated and described, for example, in connection with FIG. 5. The layer 1050 also may comprise programmed instructions that are configured to support virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different mobile computing devices 110 associated with different users. Further, the system 116 and/or data server 108 may be implemented using two or more processors, cores, clusters, or instances of physical machines or virtual machines, configured in a discrete location or co-located with other elements in a datacenter, shared computing facility or cloud computing facility.

In an embodiment, the implementation of the functions described herein using one or more computer programs or other software elements that are loaded into and executed using one or more general-purpose computers will cause the general-purpose computers to be configured as a particular machine or as a computer that is specially adapted to perform the functions described herein. Further, each of the flow diagrams that are described herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for disclosures of this type.

In an embodiment, user 104 interacts with agricultural computer system 116 using field manager computing device 110 configured with an operating system and one or more application programs or apps. The field manager computing device 110 also may interoperate with the agricultural computer system 116 independently and automatically under program control or logical control and direct user interaction is not always required. Field manager computing device 110 broadly represents one or more of a smart phone, PDA, tablet computing device, laptop computer, desktop computer, workstation, or any other computing device capable of transmitting and receiving information and performing the functions described herein. Field manager computing device 110 may communicate via a network using a mobile application stored on field manager computing device 110, and in some embodiments, the device may be coupled using a cable or connector to one or more sensors and/or other apparatus in the system 100. A particular user 104 may own, operate or possess and use, in connection with system 100, more than one field manager computing device 110 at a time.

The mobile application associated with the field manager computing device 110 may provide client-side functionality, via the network to one or more mobile computing devices. In an example embodiment, field manager computing device 110 may access the mobile application via a web browser or a local client application or app. Field manager computing device 110 may request data from, transmit data to, and receive data from, one or more front-end servers, using web-based protocols, or formats, such as HTTP, XML and/or JSON, or app-specific protocols. In an example embodiment, the data may take the form of requests and user information input, such as field data, into the mobile computing device. In some embodiments, the mobile application interacts with location tracking hardware and software on field manager computing device 110 which determines the location of field manager computing device 110 using standard tracking techniques, such as multilateration of radio signals, the global positioning system (GPS), WiFi positioning systems, or other methods of mobile positioning. In some cases, location data or other data associated with the device 110, user 104, and/or user account(s) may be obtained by queries to an operating system of the device or by requesting an app on the device to obtain data from the operating system.

In an embodiment, in addition to other functionalities described herein, field manager computing device 110 sends field data to agricultural computer system 116 comprising or including, but not limited to, data values representing one or more of: a geographical location of the one or more fields, tillage information for the one or more fields, crops planted in the one or more fields, and soil data extracted from the one or more fields. Field manager computing device 110 may send field data in response to user input from user 104 specifying the data values for the one or more fields. Additionally, field manager computing device 110 may automatically send field data when one or more of the data values becomes available to field manager computing device 110. For example, field manager computing device 110 may be communicatively coupled to a remote sensor in the system 100, and in response to an input received at the sensor, field manager computing device 110 may send field data to agricultural computer system 116 representative of the input. Field data identified in this disclosure may be input and communicated using electronic digital data that is communicated between computing devices using parameterized URLs over HTTP, or another suitable communication or messaging protocol. In that sense, in some aspects of the present disclosure, the field data provided by the field manager computing device 110 may also be stored as external data (e.g., where the field data is collected as part of harvesting crops from the growing space 102, etc.), for example, in data server 108.

A commercial example of the mobile application is CLIMATE FIELDVIEW, commercially available from Climate LLC, Saint Louis, Missouri. The CLIMATE FIELDVIEW application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it combines historical data about the grower's fields with any other data that the grower wishes to compare. The combinations and comparisons may be performed in real time and are based upon scientific models that provide potential scenarios to permit the grower to make better, more informed decisions.

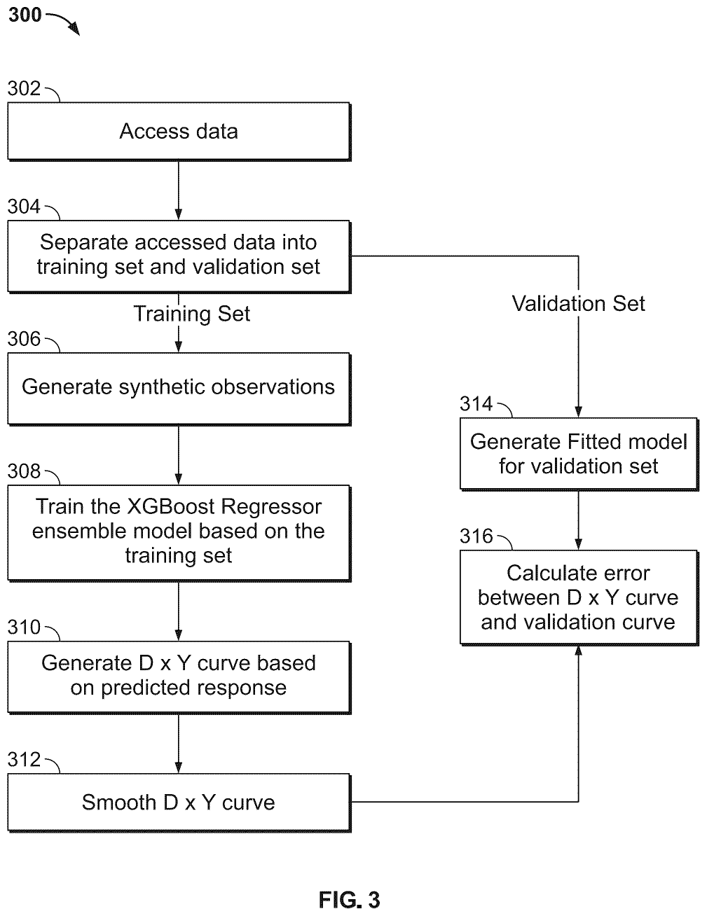

FIG. 3 illustrates an example method 300 for recommending a seeding rate, at which seeds are to be planting in a field or in numerous fields. The example method 300 is described herein in connection with the system 100, and may be implemented, in whole or in part, in the agricultural computer system 116 of the system 100. However, it should be appreciated that the method 300, or other methods described herein, are not limited to the system 100 or the agricultural computer system 116. And, conversely, the systems, data structures, and the computing devices described herein are not limited to the example method 300.

Initially, it should be appreciated that the method 300 may be executed in response to a request from the user 104, or a request related to the user 104. For example, the user 104 may provide an input to a mobile application indicative of the fields 103, and a request for recommendation as to seeding rates for one or more of the fields 103. Alternatively, a seed provider associated with the user 104 may request various seeding rate recommendations for the fields 103, in an effort to confirm and/or alter the user's plan for planting the fields 103 (e.g., with regard to seeding rate, etc.).

In response to the request, the agricultural computer system 116 accesses, at 302, data related to the fields 103 and/or fields in the same region as the fields 103 (e.g., field data, etc.). The accessed data includes, without limitation, yield data, seeding rates, nitrogen, field location (e.g., latitude/longitude, etc.), soil data, genetic data, etc. It should be appreciated that the data may be organized, analyzed, embedded, etc., in one or more manners to engineer the data to be used as described below. For example, the genetic data may include certain marker data encoded, for example, by an auto encoder, to reduce the number of features thereof. Other feature engineering may be employed to modify and or summarize the accessed data. Further, in one or more embodiments, the accessed data includes weather data.

It should be appreciated that still other data may be accessed by the agricultural computer system 116 in other method embodiments.

At 304, the agricultural computer system 116 separates the accessed data into a training set and a validation set. The separation of the data may be based on holding out specific years and/or environments of data. For example, the training set may include all years of data but one (or two, or three, etc.), which defines the validation set. Or, the agricultural computer system 116 may randomly select field-years from research trials that test a product over a range of seeding rates and utilize those data points for testing. All product and seeding rate observations from the hold out fields would not be utilized for model training (but may be used as part of a validation set, etc.).

Next, as shown in FIG. 3, the agricultural computer system 116 generates, at 306, synthetic observations based on the training set. The synthetic observations include additional observations, which are consistent with the accessed data included in the training set. In particular, the agricultural computer system 116 plots the data points of the training set and further fits a curve to the data points of the training set. In this example embodiment, the curve is a Malthus fitted model with Gaussian noise. In connection therewith, the curve provides an estimate of the underlying distribution, while the noise then adds variance around this mean to more accurately represent real world data and to prevent/inhibit overfitting of the underlying model. The points along the fitted model then are identified, at different seeding rates, to provide the synthetic observations. The agricultural computer system 116 adds the synthetic observations to the training set. In one or more embodiments, the synthetic observations are limited to about 10%, 20%, 40% or 50%, or some other percentage (i.e., lower or higher, or discrete values in between), in order to avoid, for example, over-indexing on the synthetic observations, when training the model, as explained below.

At 308, the agricultural computer system 116 trains the model, which in this example embodiment, includes an XGBoost Regressor, and in particular, an ensemble of XGBoost Regressors. The model is trained, by the agricultural computer system 116, based on the training set (which includes the original observations from the accessed data and also the synthetic observations). It should be appreciated that other models may be used in other embodiments.

As indicated above, in this example embodiment, the model is an ensemble model. The ensemble model is defined by a number of members, which is controlled by the n_ensemble_elements parameters in the model configuration. In this example embodiment, the ensemble model may be defined by ten ensemble members, yet the number of ensemble members may be more or less in other embodiments. In connection therewith, the number of XGBRegressor ensembles determines the number of models that are part of the model ensemble. Each ensemble member is trained on the training data and also defined by different values for the parameters and trained decision trees (and other trained characteristics) thereof. The prediction from the ensemble is then averaged to generate, at 310, the model D×Y curve, for each region and seed type, for example, of prediction of yield versus seeding rate. The curve or D×Y curve, which is indicative of a yield response per seeding rate (or Density (D) by Yield (Y)), may be employed in the next steps. Alternatively, the curve, which may include a non-continuous yield density response showing a jagged response and often flat steps, may be smoothed by the agricultural computer system 116, at 312. In particular, the agricultural computer system 116 may generate a smoothed D×Y curve as a fitted model, consistent with the above, to the predicted D×Y curve.

Next, in FIG. 3, at 314, the agricultural computer system 116 generates a fitted curve for the validation set. The fitted curve is, consistent with the above, based on plotting the data points of the validation set and further fitting a curve to the data points of the validation set. The agricultural computer system 116 then calculates the error between the model D×Y curve from the XGBRegressor ensemble, relative to the fitted curve generated from the validation set, at 316. The error may include the RMSE explained above, or other suitable error measuring/calculating techniques, etc. The RMSE, in turn, is then employed to measure the yield prediction, yield curve, and seeding rate accuracy.

The agricultural computer system 116 then calculates the ROI as a separate measurement and compares economics of the model predicted rate compared to the grower rate using the observed fitted curve. That is, the agricultural computer system 116 calculates the profit of the seeding rate selected by a grower, based on the grain price and the seed cost (i.e., \hat{P}_{obs}, P_{grower}, P_{model}, etc.), and then calculates the profit lift based on the different combinations, where, for example, the maximum profit lift for profit of observed (fitted curve) minus profit of the grower and the profit lift for the profit of the model minus the profit of the grower. Based on that, for various different seeding rates, a win rate is calculated by the agricultural computer system 116 consistent with the below equation, where test is the test number, x is the seeding rate of the different seeding rates, and P_lift is the proportion of time that P_lift is greater than zero.

$${win}_{rate} = \frac{{\sum }_{x ∈ test} {1}_{( {P}_{lift} > 0 )} ( x )}{\vert test \vert}$$

In turn, the agricultural computer system 116 outputs a seeding rate recommendation (or recommendations) to the user 104 based, for example, on the win rate(s). For instance, the win rate(s) may be compared to one or more thresholds and, based on the comparison, one or more seeding rate recommendation may be determined. The recommendation(s) may be provided in a table, in which the predicted yields are included or may be included in an interface along with a basis for the selection, recommendation metrics, field guide information, etc. In doing so, the recommendation(s) may be compared to a current seeding rate used by the user 104. Further, the recommendation(s) may be used to generate a planting prescription for a field, at the recommended seeding rate (and, in some embodiments, regenerated based on user input, etc.).

The seeding rate recommendation may then be selected by the user 104, via a field manager computing device 110 associated with the user 104. This may include the agricultural computer system 116 generating a prescription for a field (e.g., one or more of the fields 103, etc.) and transmitting the prescription to the user 104. In addition, based on the selection, the user 104 may order and/or purchase particular seeds/hybrids, for instance, via the agricultural computer system 116, etc. (e.g., whereby the agricultural computer system 116 receives the order, purchase request, etc. from the grower/user, in response to output of the seeding rate to the grower/user 104 and a corresponding selection by the grower/user; etc.), and then the agricultural computer system 116 directs the seeds/hybrids to the user 104 (e.g., delivering the selected seeds to the target field, etc.), for planting via the planting equipment 106a-b, etc. In some embodiments, following the selection by the user 104, the order may be implemented automatically by the agricultural computer system 116. In addition, in some embodiments, following the selection by the use 104, the agricultural computer system 116 may update (or modify) and existing order (or a standing order) for the user 104, based on the recommended seeding rate(s).

In addition, or alternatively, the agricultural computer system 116 may transmit the recommendation(s) and/or generated prescriptions to a computing device associated with the planting devices 106a-b (e.g., a cab computer associated therewith, etc.). In doing so, broadly, the desired seeds are included (e.g., planted, etc.) in the fields 103, by the planting equipment 106a-b, at the recommended seeding rate, based on one or more scripts generated and/or compiled by the agricultural computer system 116. This may include the agricultural computer system 116 generating planting instructions—as the script(s)—based on the seeding rate recommendation and providing the instructions to the planting equipment 106a-b whereby the planting equipment 106a-b operates, in response to the instructions, to plant the seeds at that rate in the fields 103, with only limited additional input from the user 104 (e.g., upon delivery of the selected seeds to the planting equipment 106a-b, etc.). In one or more embodiments, the planting equipment 106a-b may be controlled automatically, through the scripts generated, by the agricultural computer system 116, in response to the user's selection and/or the identification by the agricultural computer system 116.

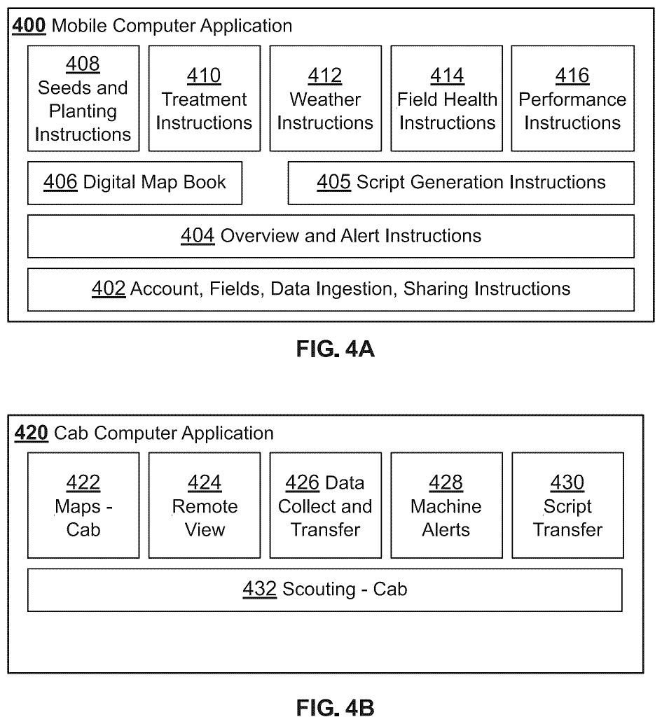

FIGS. 4A and 4B illustrate two views of an example logical organization of sets of instructions in main memory when an example mobile application is loaded for execution. In FIGS. 4A and 4B, each named element represents a region of one or more pages of RAM or other main memory, or one or more blocks of disk storage or other non-volatile storage, and the programmed instructions within those regions. In one embodiment, in FIG. 4A, a mobile computer application 400 comprises account, fields, data ingestion, sharing instructions 402, overview and alert instructions 404, digital map book instructions 406, seeds and planting instructions 408, treatment instructions 410, weather instructions 412, field health instructions 414, and performance instructions 416.

In one embodiment, a mobile computer application 400 comprises account, fields, data ingestion, sharing instructions 402 which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 400 comprises a data inbox. In response to receiving a selection of the data inbox, the mobile computer application 400 may display a graphical user interface for manually uploading data files and importing uploaded files to a data manager.

In one embodiment, digital map book instructions 406 comprise field map data layers stored in device memory and are programmed with data visualization tools and geospatial field notes. This provides growers with convenient information close at hand for reference, logging and visual insights into field performance. In one embodiment, overview and alert instructions 404 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 408 are programmed to provide tools for seed selection, hybrid placement, and script creation, including variable rate (VR) script creation, based upon scientific models and empirical data. This enables growers to improve and/or maximize yield or return on investment through optimized seed purchase, placement and population.

In one embodiment, script generation instructions 405 are programmed to provide an interface for generating scripts, including variable rate (VR) fertility scripts. The interface enables growers to create scripts for field implements, such as nutrient applications, planting, and irrigation. For example, a planting script interface may comprise tools for identifying a type of seed for planting. Upon receiving a selection of the seed type, mobile computer application 400 may display one or more fields broken into management zones, such as the field map data layers created as part of digital map book instructions 406. In one embodiment, the management zones comprise soil zones along with a panel identifying each soil zone and a soil name, texture, drainage for each zone, or other field data. Mobile computer application 400 may also display tools for editing or creating such, such as graphical tools for drawing management zones, such as soil zones, over a map of one or more fields. Planting procedures may be applied to all management zones or different planting procedures may be applied to different subsets of management zones. When a script is created, mobile computer application 400 may make the script available for download in a format readable by an application controller, such as an archived or compressed format. Additionally, and/or alternatively, a script may be sent directly to cab computer 115 from mobile computer application 400 and/or uploaded to one or more data servers and stored for further use.

In one embodiment, treatment instructions 410 are programmed to provide tools to inform treatment decisions by visualizing the availability of treatments to crops. This enables growers to improve and/or maximize yield or return on investment through the parameters of certain treatments (e.g., nitrogen, fertilizer, fungicides, other nutrients (such as phosphorus and potassium), pesticide, and irrigation, etc.) applied during the season. Example programmed functions include displaying images such as SSURGO images to enable drawing of fertilizer application zones and/or images generated from subfield soil data, such as data obtained from sensors, at a high spatial resolution (as fine as millimeters or smaller depending on sensor proximity and resolution); upload of existing grower-defined zones; providing a graph of plant nutrient availability and/or a map to enable tuning application(s) of nitrogen across multiple zones; output of scripts to drive machinery; tools for mass data entry and adjustment; and/or maps for data visualization, among others.

“Mass data entry,” in this context, may mean entering data once and then applying the same data to multiple fields and/or zones that have been defined in the system; example data may include treatment application data that is the same for many fields and/or zones of the same grower, but such mass data entry applies to the entry of any type of field data into the mobile computer application 400. For example, treatment instructions 410 may be programmed to accept definitions of application and practices programs and to accept user input specifying to apply those programs across multiple fields. For example, “nitrogen application programs,” in this context, refers to stored, named sets of data that associates: a name, color code or other identifier, one or more dates of application, types of material or product for each of the dates and amounts, method of application or incorporation such as injected or broadcast, and/or amounts or rates of application for each of the dates, crop or hybrid that is the subject of the application, among others. Such “nitrogen practices programs,” in this context, refer to stored, named sets of data that associates: a practices name; a previous crop; a tillage system; a date of primarily tillage; one or more previous tillage systems that were used; one or more indicators of application type, such as manure, that were used. Treatment instructions 410 also may be programmed to generate and cause displaying a treatment graph, which indicates projections of plant use of the specified treatment and whether a surplus or shortfall is predicted; in some embodiments, different color indicators may signal a magnitude of surplus or magnitude of shortfall. In one embodiment, a treatment graph comprises a graphical display in a computer display device comprising a plurality of rows, each row associated with and identifying a field; data specifying what crop is planted in the field, the field size, the field location, and a graphic representation of the field perimeter; in each row, a timeline by month with graphic indicators specifying each treatment applied and amount at points correlated to month names; and numeric and/or colored indicators of surplus or shortfall, in which color indicates magnitude.

In one embodiment, the treatment graph may include one or more user input features, such as dials or slider bars, to dynamically change the treatment planting and practices programs so that a user may alter the treatment graph. The user may then use his treatment graph and the related treatment planting and practices programs to implement one or more scripts, including variable rate (VR) fertility scripts. Treatment instructions 410 also may be programmed to generate and cause displaying a treatment map, which indicates projections of plant use of the specified treatment and whether a surplus or shortfall is predicted; in some embodiments, different color indicators may signal a magnitude of surplus or magnitude of shortfall. The treatment map may display projections of plant use of the specified treatment and whether a surplus or shortfall is predicted for different times in the past and the future (such as daily, weekly, monthly or yearly) using numeric and/or colored indicators of surplus or shortfall, in which color indicates magnitude. In one embodiment, the treatment map may include one or more user input features, such as dials or slider bars, to dynamically change the treatment planting and practices programs so that a user may alter his treatment map, such as to obtain a preferred amount of surplus to shortfall. The user may then use his optimized treatment map and the related treatment planting and practices programs to implement one or more scripts, including variable rate (VR) fertility scripts.

In one embodiment, weather instructions 412 are programmed to provide field-specific recent weather data and forecasted weather information. This enables growers to save time and have an efficient integrated display with respect to daily operational decisions.

In one embodiment, field health instructions 414 are programmed to provide timely remote sensing images highlighting in-season crop variation and potential concerns. Example programmed functions include cloud checking, to identify possible clouds or cloud shadows; determining indices based on field images; graphical visualization of scouting layers, including, for example, those related to field health, and viewing and/or sharing of scouting notes; and/or downloading satellite images from multiple sources and prioritizing the images for the grower, among others.

In one embodiment, performance instructions 416 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 416 may be programmed to communicate via the network(s) 109 to back-end analytics programs executed at agricultural computer system 130 and/or external data server computer 108 and configured to analyze metrics such as yield, yield differential, hybrid, population, SSURGO zone, soil test properties, or elevation, among others. Programmed reports and analysis may include yield variability analysis, treatment effect estimation, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience or a cab app experience that is suitable for the display and processing capabilities of cab computer 115. For example, referring now to FIG. 4B, in one embodiment a cab computer application 240 may comprise maps-cab instructions 422, remote view instructions 424, data collect and transfer instructions 426, machine alerts instructions 428, script transfer instructions 430, and scouting-cab instructions 432. The code base for the instructions of FIG. 4B may be the same as for FIG. 4A and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 422 may be programmed to provide map views of fields, farms or regions that are useful in directing machine operation. The remote view instructions 424 may be programmed to turn on, manage, and provide views of machine activity in real-time or near real-time to other computing devices connected to the system 130 via wireless networks, wired connectors or adapters, and the like. The data collect and transfer instructions 426 may be programmed to turn on, manage, and provide transfer of data collected at sensors and controllers to the system 130 via wireless networks, wired connectors or adapters, and the like. The machine alerts instructions 428 may be programmed to detect issues with operations of the machine or tools that are associated with the cab and generate operator alerts. The script transfer instructions 430 may be configured to transfer in scripts of instructions that are configured to direct machine operations or the collection of data. The scouting-cab instructions 432 may be programmed to display location-based alerts and information received from the system 130 based on the location of the field manager computing device 104, agricultural apparatus 111, or sensors 112 in the field and ingest, manage, and provide transfer of location-based scouting observations to the system 130 based on the location of the agricultural apparatus 111 or sensors 112 in the field.

For example, FIG. 5 is a block diagram that illustrates a computer system 500 upon which one or more embodiments of the present disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), liquid crystal display (LCD), light emitting diode (LED), etc., for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device may, for example, have two degrees of freedom in two axes, a first axis (e.g., x, etc.) and a second axis (e.g., y, etc.), that allows the device to specify positions in a plane. The input device 514, more generally, includes any device through which the user is permitted to provide an input, data, etc., to the computer system 500.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infrared data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infrared signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 430 might transmit a requested code for an application program through Internet 528, ISP 526, local network 522 and communication interface 518.

The received code may be executed by processor 504 as it is received, and/or stored in storage device 510, or other non-volatile storage for later execution.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the steps/operations recited in the claims, including, for example: (a) accessing data related to multiple agricultural fields in a region, the data including multiple observations, which are indicated by yield of the multiple agricultural fields over at least one season, seeding rate of the multiple agricultural fields over the at least one season, location, soil data representative of the multiple agricultural fields, and genetic data for seeds planted in the multiple agricultural fields over the at least one season; (b) separating the accessed data into a training set and a validation set, based on timing associated with harvest of crops of the multiple agricultural fields; (c) training an ensemble of models, representative of seeding rate relative to yield, based on the training set; (d) generating a response curve, defining a yield response to seeding rate, based on the trained ensemble of models; (e) generating a validation curve, based on the validation set; (f) calculating an error between the generated response curve and the validation curve; (g) recommending a seed rate for a target field in the region, based on the response curve and the calculated error; (h) generating multiple synthetic observations based on the training set; (i) adding the multiple synthetic observations to the multiple observations of the training set for the multiple agricultural fields, prior to training the ensemble of models; (j) determining a seeding rate recommendation and a return on investment associated with the seeding rate, based on the response curves; and/or (k) causing planting of the agricultural field consistent with the recommended seeding rate.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in recommending seeding rates for one or more agricultural fields, the method comprising:
accessing, by a computing device, data related to multiple agricultural fields in a region, the data including multiple observations, which are indicated by yield of the multiple agricultural fields over at least one season, seeding rate of the multiple agricultural fields over the at least one season, location, soil data representative of the multiple agricultural fields, and genetic data for seeds planted in the multiple agricultural fields over the at least one season;
separating, by the computing device, the accessed data into a training set and a validation set, based on timing associated with harvest of crops of the multiple agricultural fields;
training an ensemble of models, representative of seeding rate relative to yield, based on the training set;
generating a response curve, defining a yield response to seeding rate, based on the trained ensemble of models;
generating a validation curve, based on the validation set;
calculating an error between the generated response curve and the validation curve; and
recommending a seeding rate for a target field in the region, based on the response curve and the calculated error.

2. The computer-implemented method of claim 1, wherein the at least one season includes multiple seasons over multiple years; and/or
wherein the soil data include one or more of: bulk density of the fine earth fraction, cation exchange capacity of the soil, volume fraction of coarse fragments, nitrogen, phh2o, sand, silt, and/or soil organic carbon.

3. The computer-implemented method of claim 1, further comprising generating multiple synthetic observations based on the training set; and
adding the multiple synthetic observations to the multiple observations of the training set for the multiple agricultural fields, prior to training the ensemble of models.

4. The computer-implemented method of claim 1, wherein generating the response curve includes:
averaging the predicted values from the ensemble of models; and
fitting a smoothed curve to the averaged values.

5. The computer-implemented method of claim 1, further comprising determining a seeding rate recommendation and a return on investment associated with the seeding rate, based on the response curves; and
wherein recommending the seeding rate for the target field in the region is further based on the return on investment.

6. The computer-implemented method of claim 1, further comprising planting the agricultural field consistent with the recommended seeding rate.

7. The computer-implemented method of claim 1, further comprising transmitting, by the computing device, an order request for seeds based on the recommended seeding rate.

8. A system for use in recommending seeding rates for one or more agricultural fields, the system comprising at least one computing device configured to:
access data related to multiple agricultural fields in a region, the data including multiple observations, which are indicated by yield of the multiple agricultural fields over at least one season, seeding rate of the multiple agricultural fields over the at least one season, location, soil data representative of the multiple agricultural fields, and genetic data for seeds planted in the multiple agricultural fields over the at least one season;
separate the accessed data into a training set and a validation set, based on timing associated with harvest of crops of the multiple agricultural fields;
train an ensemble of models, representative of seeding rate relative to yield, based on the training set;
generate a response curve, defining a yield response to seeding rate, based on the trained ensemble of models;
generate a validation curve, based on the validation set;
calculate an error between the generated response curve and the validation curve; and
recommend a seeding rate for a target field in the region, based on the response curve and the calculated error.

9. The system of claim 8, wherein the at least one season includes multiple seasons over multiple years; and/or
wherein the soil data include one or more of: bulk density of the fine earth fraction, cation exchange capacity of the soil, volume fraction of coarse fragments, nitrogen, phh2o, sand, silt, and/or soil organic carbon.

10. The system of claim 8, wherein the at least one computing device is further configured to:
generate multiple synthetic observations based on the training set; and
add the multiple synthetic observations to the multiple observations of the training set for the multiple agricultural fields, prior to training the ensemble of models.

11. The system of claim 8, wherein the at least one computing device is configured, in order to generate the response curve, to:
average the predicted values from the ensemble of models; and
fit a smoothed curve to the averaged values.

12. The system of claim 8, wherein the at least one computing device is further configured to determine a seeding rate recommendation and a return on investment associated with the seeding rate, based on the response curves; and
wherein the at least one computing device is configured to recommend the seeding rate for the target field in the region is further based on the return on investment.

13. The system of claim 8, wherein the at least one computing device is further configured to transmit the seeding rate to a planting device, to thereby cause planting of the agricultural field, by the planting device, consistent with the recommended seeding rate.

14. A non-transitory computer readable storage medium including executable instructions for recommending seeding rates, which when executed by at least one processor, cause the at least one processor to:
access data related to multiple agricultural fields in a region, the data including multiple observations, which are indicated by yield of the multiple agricultural fields over at least one season, seeding rate of the multiple agricultural fields over the at least one season, location, soil data representative of the multiple agricultural fields, and genetic data for seeds planted in the multiple agricultural fields over the at least one season;
separate the accessed data into a training set and a validation set, based on timing associated with harvest of crops of the multiple agricultural fields;
train an ensemble of models, representative of seeding rate relative to yield, based on the training set;
generate a response curve, defining a yield response to seeding rate, based on the trained ensemble of models;
generate a validation curve, based on the validation set;
calculate an error between the generated response curve and the validation curve; and
recommend a seeding rate for a target field in the region, based on the response curve and the calculated error.

15. The non-transitory computer readable storage medium of claim 14, wherein the at least one season includes multiple seasons over multiple years; and/or
wherein the soil data include one or more of: bulk density of the fine earth fraction, cation exchange capacity of the soil, volume fraction of coarse fragments, nitrogen, phh2o, sand, silt, and/or soil organic carbon.

16. The non-transitory computer readable storage medium of claim 14, wherein the executable instructions, when executed by the at least one processor, further cause the at least one processor to:
generate multiple synthetic observations based on the training set; and
add the multiple synthetic observations to the multiple observations of the training set for the multiple agricultural fields, prior to training the ensemble of models.

17. The non-transitory computer readable storage medium of claim 14, wherein the executable instructions, when executed by the at least one processor to generate the response curve, cause the at least one processor to:
average the predicted values from the ensemble of models; and
fit a smoothed curve to the averaged values.

18. The non-transitory computer readable storage medium of claim 14, wherein the executable instructions, when executed by the at least one processor, further cause the at least one processor to determine a seeding rate recommendation and a return on investment associated with the seeding rate, based on the response curves; and
wherein the executable instructions, when executed by the at least one processor to recommend the seeding rate for the target field in the region, cause the at least one processor recommend the seed rate based on the return on investment.

19. The non-transitory computer readable storage medium of claim 14, wherein the executable instructions, when executed by the at least one processor, further cause the at least one processor to transmit the seeding rate to a planting device, to thereby cause planting of the agricultural field, by the planting device, consistent with the recommended seeding rate.
